(19) United States
(12) Patent Application Publication
(10) Pub. No.: US 2004/0236856 A1
(43) Pub. Date: Nov. 25, 2004

(54) Method and apparatus for prioritizing users in a wireless hub

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY (US)

(21) Appl. No.: 10/443,676

(22) Filed: May 22, 2003

(51) Int. Cl. G06F 15/173; G06F 15/16

(52) U.S. Cl. 709/229; 709/224

(57) ABSTRACT

The present invention relates to a method, apparatus, and computer instructions for creating and monitoring network connections of prioritized users in a wireless hub. All users of a wireless hub are assigned priorities for their connections to the wireless hub. These priorities may be based on categories, such as for example, fees paid, importance of traffic, amount of traffic, type of work, alternate physical connection availability, and job level. When a user logs onto a wireless hub with a network card, the IP address or port is logged. The user may be identified through their MAC address. Performance thresholds for a network may be used to determine whether or not the performance level of the network is acceptable. If the performance level of the network reaches a specified unfavorable threshold, then the connection of non-priority and lower prioritized users may be dropped.

### BACKGROUND OF THE INVENTION

1. Technical Field

The present invention relates to an improved data processing system. In particular, the present invention relates to a method, apparatus, and computer program product for prioritizing users in a wireless hub.

2. Description of Related Art

Modern communications depends on networks. A network is a set of interconnected machines (network elements) that allow data to be relayed across the set of machines from a source to a destination. Networks may be classified according to the geographic area they occupy. A local area network (LAN) is usually defined as a network that is physically limited to a relatively small area, such as a building or group of buildings. A wide area network (WAN) is a general term for a network of larger size. A wireless LAN transmits over the air and does not require its network elements to be within the line of sight transmission. The IEEE 802.11 standard from the Institute of Electrical and Electronics Engineers (IEEE) is an example of a standard for wireless LANs that is in wide use today.

A network's performance is severely decreased when too many users are on the network. Hubs, are hardware devices that are used to connect a set of individual machines to a network. In an “infrastructure-based” wireless LAN, a wireless hub (also called an “access point”) is used to provide wireless network connections to a set of machines. A wireless hub may also act as a bridge between a wireless LAN and a wire- or cable-based network, such as an Ethernet. Hubs, including wireless hubs, have a limited number of connections, and once the limit is reached, a new connection cannot be made until a current connection is dropped or released. For example, if multiple users are in a conference room trying to access a network through a wireless hub, the performance of the network would decrease and some of the users may not be able to access the network. There may be times that users who have a more immediate need for access the network, cannot access the network while other users who may have less of an immediate need to access the network are connected to the network.

Therefore, there is a need for a solution to the problem of ensuring network access to those users having more immediate need of access.

### SUMMARY OF THE INVENTION

The present invention relates to a method, apparatus, and computer instructions for creating and monitoring network connections of prioritized users in a wireless hub. All users of a wireless hub are assigned priorities for their connections to the wireless hub. These priorities may be based on categories, such as for example, fees paid, importance of traffic, amount of traffic, type of work, alternate physical connection availability, and job level. When a user logs onto a wireless hub with a network card, the IP address or port is logged. The user may be identified through their MAC address. Performance thresholds for a network may be used to determine whether or not the performance level of the network is acceptable. If the performance level of the network reaches a specified unfavorable threshold, then the connection of non-priority and lower prioritized users may be dropped.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system in which the present invention may be implemented;

FIG. 4 is a block diagram of a wireless local area network that may be implemented in accordance with a preferred embodiment of the present invention;

FIG. 5 is a block diagram of a process to create and monitor prioritized users for a wireless hub in accordance with a preferred embodiment of the present invention;

FIG. 6 is a flowchart of a process for creating prioritized users on a network in accordance with a preferred embodiment of the present invention;

FIG. 7 is a flowchart of a process for logging user connections through a wireless hub to a network in accordance with a preferred embodiment of the present invention; and

FIG. 8 is a flowchart of a process for monitoring prioritized users on a wireless hub in accordance with a preferred embodiment of the present invention.

### DETAILED DESCRIPTION OF THE PREFERRED EMBODIMENT

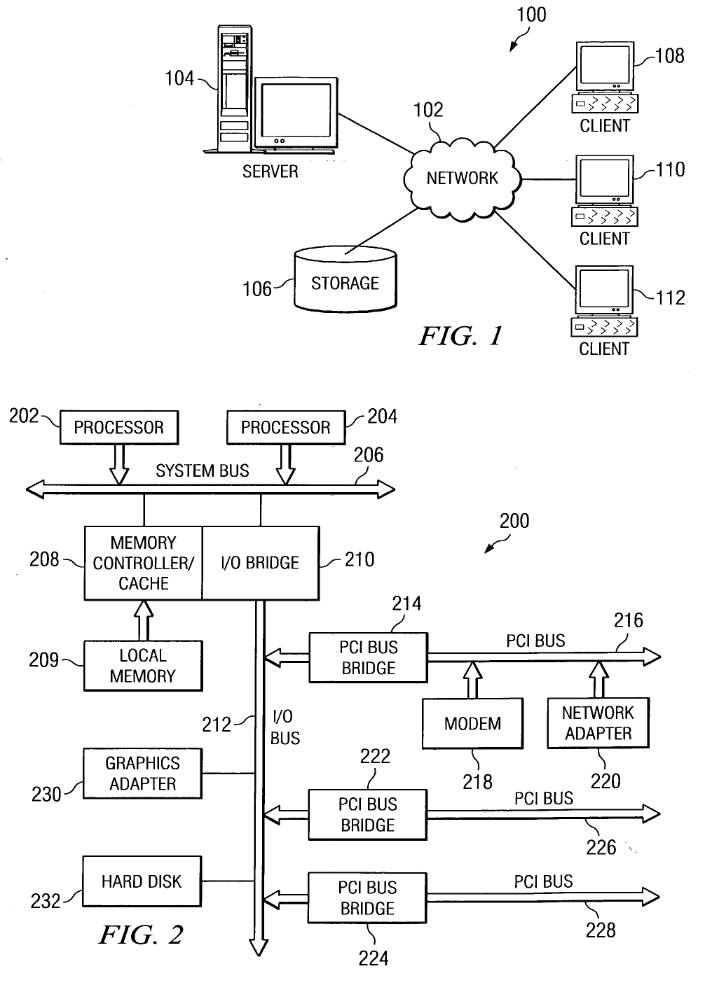

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers, such as desktop, laptop, or hand held computers, transactional systems, or network computers. In the depicted example, server 104 provides data, such as boot files, operating system images, and applications to clients 108-112. Clients 108, 110, and 112 are clients to server 104, or application-to-application, such as in transactional systems. Network data processing system 100 may include additional servers, clients, and other devices not shown. In the depicted example, network data processing system 100 is the Internet with network 102 representing a worldwide collection of networks and gateways that for example, use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Network data processing systems 100 may include wireless access points (base stations) to provide communications for a computer, such as clients 108, 110, and 112. Wireless technology, such as Bluetooth, 802.11, WPAN, HomeRF, HIPERLAN, and IrDA, may be implemented in network data processing systems 100.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eserver pSeries system, a product of International Business Machines Corporation in Armonk, N.Y., running the Advanced Interactive Executive (AIX) operating system or LINUX operating system.

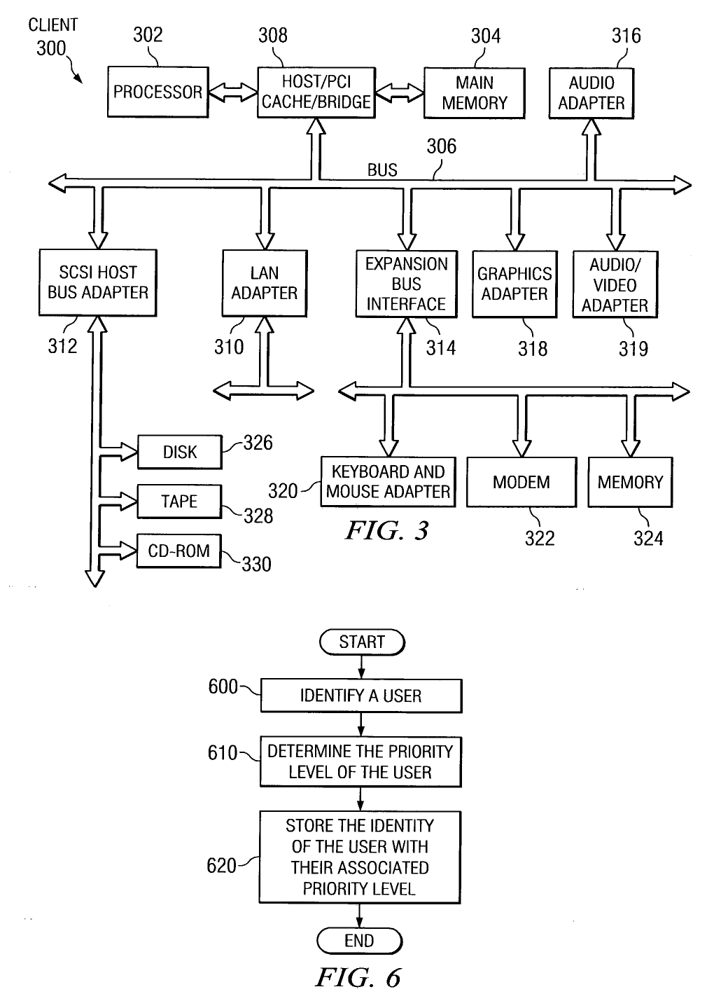

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as “Windows XP”, which is a trademark of Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. In a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a laptop computer or hand held computer in addition to taking the form of a PDA. Data processing system 300 also may be a kiosk or a Web appliance.

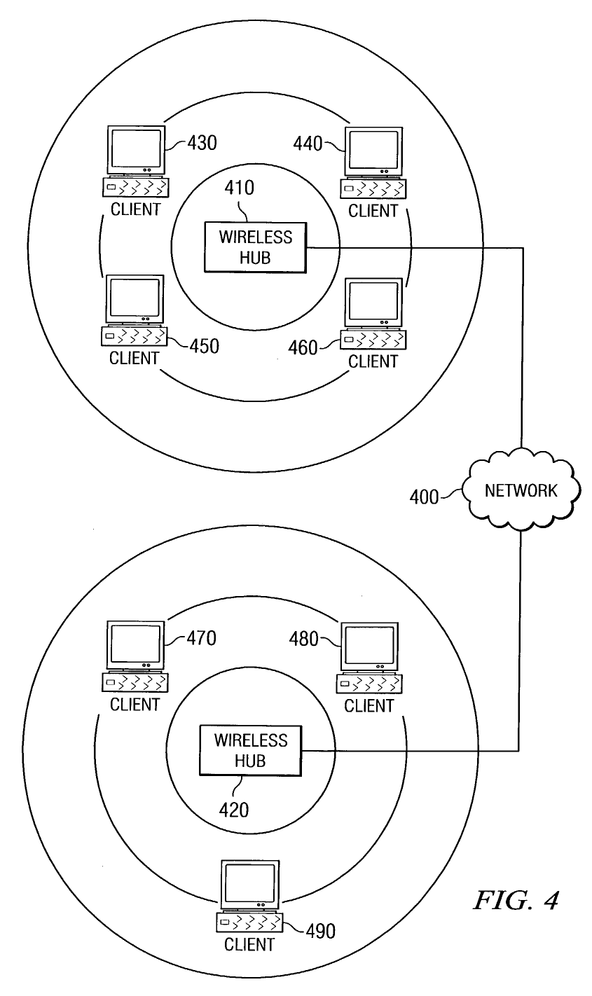

Referring now to FIG. 4, a block diagram is displayed illustrating a local area network that may be implemented in accordance with a preferred embodiment of the present invention. Network 400 is a local area network with wireless hubs, such as wireless hubs 410 and 420. Wireless hubs 410 and 420 may be connected to via an Ethernet or other form of wire- or cable-based network to others hubs, servers, or routers within network 400.

Wireless hubs 410 and 420 transmit and receive radio frequency signals over an area typically ranging from several hundred to a thousand feet. Since wireless hubs can penetrate walls and other non-metal barriers, clients may connect to a wireless hub while within the signal range for that wireless hub. Repeaters and other range-extending devices for extending the signal range of a wireless hub are also known in the art. For example in FIG. 4, clients 430, 440, 450, and 460 may connect to wireless hub 410 and clients 470, 480, and 490 may connect to wireless hub 420. A connection may be a transport-layer connection, such as TCP or other communication protocol, a wireless connection using IEEE standard 802.11 or other wireless media, or any other form of connection, whether in a physical medium or with respect to a networking protocol.

Roaming users may move from one wireless hub to another. For example, wireless hub 410 may be located on the second floor of a building and wireless hub 420 may be located on the fourth floor of the building. If client 430 moves to the fourth floor, client 430 may connect to wireless hub 420 rather than wireless hub 410.

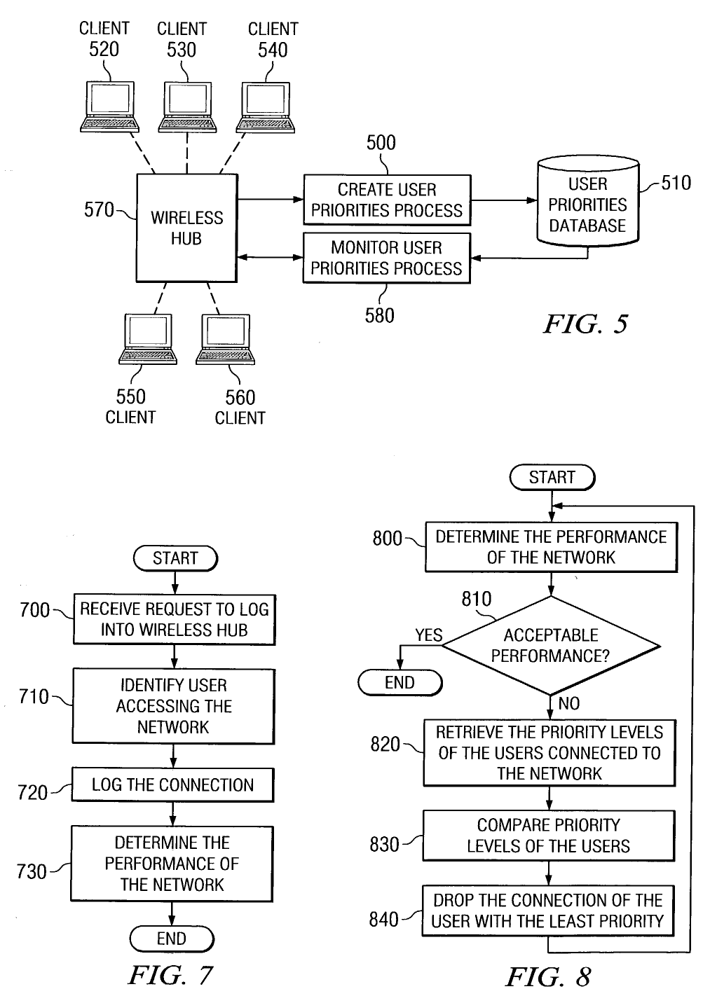

Next, FIG. 5 is a block diagram of processes to create and monitor user priorities for a wireless hub in accordance with a preferred embodiment of the present invention. Create user priorities process 500 identifies a user and assigns a priority level for that user. The user may be identified using the Media Access Control (MAC) address for the user's network adapter or network interface card (NIC). The MAC address is a globally-unique serial number burned into network adapters that distinguish a specific network adapter from all other network adapters. Both wireless and non-wireless network adapters have MAC addresses. The identity and priority of a user is stored in priority user database 510.

When a client, such as clients 520, 530, 540, 550, and 560, client 300 in FIG. 3, and clients 430, 440, 450, 460, 470, 480, and 490 in FIG. 4, connects to wireless hub 570, the MAC address from the client's wireless network adapter may be retrieved. Monitor prioritized users process 580 may use the MAC address and priority user database 510 to determine the priority level of a user connecting to the network. If the performance level of the network is low (e.g., due to excessive network traffic) or reaches a specified threshold, the connection of non-priority or low-priority users may be dropped or eliminated to give the higher-priority users full bandwidth. In an alternative embodiment in which a network has multiple connection rates, a higher-priority user may receive a greater level of bandwidth.

Wireless hub 570 may grant higher-priority users access to the network over users with a lower priority. For example, if multiple wireless users were in a conference room trying to access a network, then the higher-priority users would be given access over non-priority or low-priority users. If a network's performance level becomes slow, then the wireless hub can drop non-priority or low-priority users to increase network performance for the higher-priority users.

Turning to FIG. 6, a flowchart is displayed of a process for creating user priorities on a network in accordance with a preferred embodiment of the present invention. A user must be authenticated to have access to the network; this is a network service to the user. At the time of user authentication, the user's identity and priority information would be stored, for example, in a network server's database where user authentication information exists.

A user is identified through the user's connection to a wireless hub (step 600), via the MAC address of the user's network adapter, for example. The user must register their MAC address. The MAC addresses are stored, for example, in a database on a network server. A priority level is determined for each user of the wireless hub (step 610). A user's priority level may be associated with a variety of criteria, such as, for example, the amount of fees paid for accessing a network, the importance of the network traffic, the amount of network traffic, the location that the user is residing on the network, a job level, a job description, and an availability for an alternate means for connecting to the network. For example, a user may have a lower priority for a wireless hub if that user can also connect to the network using a wired connection. A user paying a higher fee may have a higher priority than a person paying a lower fee. In another example, a user may have a lower priority when surfing the web than a user working on the internal domain sites. The identity of the user and the user's associated priority level is stored for subsequent retrieval (step 620) with the process terminating thereafter.

Next, FIG. 7 is a flowchart of a process for logging user connections through a wireless hub to a network in accordance with a preferred embodiment of the present invention. In the preferred embodiment, all the clients, such as clients 108, 110, and 112 in FIG. 1, client 300 in FIG. 3, clients 430, 440, 450, 460, 470, 480, and 490 in FIG. 4, and clients 520, 530, 540, 550, and 560 in FIG. 5, in a network connect to a wireless hub (also called a “centralized box”). All information passed over the network moves through the wireless hub and then to the intended computer.

A request to make a network connection through a wireless hub is received (step 700). The user attempting to access the network is identified (step 710). The user may be identified by the user's MAC address. The connection of the user is logged by recording the network address and/or a port of the connection (step 720). Performance of the network is determined (step 730) with the process terminating thereafter. Many tools exist to monitor network bandwidth and determine the network performance. Performance levels may be reduced due to the amount of network traffic and the number of users connected to the network. Thresholds are identified within the network that aid in the determination of the performance level of the network. If a specified threshold is reached, then a performance level may be considered low or unacceptable. Step 730 is described in more detail in FIG. 8.

FIG. 8 is a flowchart of a process for monitoring prioritized users on a wireless hub in accordance with a preferred embodiment of the present invention. The performance of the network is determined (step 800). This step may determine whether the performance level has reached a specified threshold. A determination is made as to whether or not the performance level is acceptable (step 810). If the performance level is not acceptable, the priority levels of the users connected to the network are retrieved (step 820). The priority levels of the users are compared to determine which users have a higher priority than other users (step 830). A connection of a user with the lower priority is eliminated or dropped to give the higher-priority users more bandwidth (step 840) with the process returning to step 800. In another embodiment of the present invention where a network has multiple connection rates, the connection of a user with a higher priority receives a greater level of bandwidth.

Returning to step 810, if the performance level is acceptable, the process terminates thereafter.

Thus, the present invention provides an improved method, apparatus, and computer instructions for creating and monitoring prioritized users for a wireless hub. Network performance is improved for higher-priority users by dropping or eliminating the connection of non-priority or lower-priority users.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for monitoring at least one priority of at least one user connected to a wireless hub, the method comprising:
determining a performance level of a network;
identifying the at least one user connected to the wireless hub;
retrieving the at least one priority of the at least one user connected to the wireless hub; and
discontinuing a communication between the at least one user and the wireless hub based on the at least one priority of the at least one user and the performance level of the network.

2. The method of claim 1, wherein the at least one priority is based on at least one of an amount of fees paid for utilizing the network, an importance of network traffic, an amount of network traffic, a type of work, an availability of an alternate physical connection to the network, a location of the at least one user within the network, a job description, and a job level.

3. The method of claim 1 further comprising:
defining thresholds to measure the performance level of the network.

4. The method of claim 3 further comprising:
evaluating the performance level of the network with respect to the thresholds.

5. The method of claim 1, wherein a Media Access Control address is used to identify the at least one user.

6. The method of claim 1, wherein at least one of a Media Access Control address, an IP address, and a port is logged when the at least one user connects to the wireless hub.

7. The method of claim 1 further comprising:
granting a greater level of bandwidth to the at least one user with a higher priority.

8. The method of claim 1, wherein the step of retrieving the at least one priority further comprises:
creating the priority level for the at least one user for utilizing the network; and
storing the priority of the at least one user.

9. A data processing system comprising:
a bus system;
a communications unit connected to the bus system;
a memory connected to the bus system, wherein the memory includes as set of instructions; and
a processing unit connected to the bus system, wherein the processing unit executes the set of instructions to determine a performance level of a network; identify the at least one user connected to the wireless hub; retrieve the at least one priority of the at least one user connected to the wireless hub; and discontinuing a communication between the at least one user and the wireless hub based on the at least one priority of the at least one user and the performance level of the network.

10. A data processing system for monitoring at least one priority of at least one user connected to a wireless hub, the data processing system comprising:
determining means for determining a performance level of a network;
identifying means for identifying the at least one user connected to the wireless hub;
retrieving means for retrieving the at least one priority of the at least one user connected to the wireless hub; and
discontinuing means for discontinuing a communication between the at least one user and the wireless hub based on the at least one priority of the at least one user and the performance level of the network.

11. The data processing system of claim 10 further comprising:
defining means for defining thresholds to measure the performance level of the network.

12. The data processing system of claim 11 further comprising:
evaluating means for evaluating the performance level of the network with respect to the thresholds.

13. The data processing system of claim 10 further comprising:
granting means for granting a greater level of bandwidth to the at least one user with a higher priority.

14. The data processing system of claim 10, wherein the step of retrieving the at least one priority further comprises:
creating means for creating the priority level for the at least one user for utilizing the network; and
storing means for storing the priority of the at least one user.

15. A computer program product in a computer readable medium for monitoring at least one priority of at least one user connected to a wireless hub, the computer program product comprising:
first instructions for determining a performance level of a network;
second instructions for identifying the at least one user connected to the wireless hub;
third instructions for retrieving the at least one priority of the at least one user connected to the wireless hub; and
fourth instructions for discontinuing a communication between the at least one user and the wireless hub based on the at least one priority of the at least one user and the performance level of the network.

16. The computer program product of claim 15 further comprising:
instructions for defining thresholds to measure the performance level of the network.

17. The computer program product of claim 16 further comprising:
instructions for evaluating the performance level of the network with respect to the thresholds.

18. The computer program product of claim 15 further comprising:
instructions for granting a greater level of bandwidth to the at least one user with a higher priority.

19. The computer program product of claim 15, wherein the step of retrieving the at least one priority further comprises:
instructions for creating the priority level for the at least one user for utilizing the network; and
instructions for storing the priority of the at least one user.
